(19) United States
(12) Patent Application Publication
(10) Pub. No.: US 2026/0244064 A1
(43) Pub. Date: Aug. 20, 2026

(54) DISPLAY MEDIUM, PROCESSING DEVICE, PROCESSING METHOD, AND PROGRAM

(71) Applicant: DWANGO CO., LTD., Chuo-ku, Tokyo (JP)

(72) Inventor: Kaisei SAKURAI, Chuo-ku, Tokyo (JP)

(73) Assignee: DWANGO CO., LTD., Chuo-ku, Tokyo (JP)

(21) Appl. No.: 19/161,831

(22) PCT Filed: Feb. 14, 2024
(86) PCT No.: PCT/JP2024/005034

§ 371 Date: Sep. 3, 2025

(30) Foreign Application Priority Data
Apr. 11, 2023 (JP) 2023-064194

(51) Int. Cl. G02F 1/16753

(52) U.S. Cl. CPC G02F 1/16753

(57) ABSTRACT

A display medium 1 displays contents which are visually recognizable by a person with no disability and a person with a color-vision-impairment who is in the minority. The display medium 1: displays, in a first direction, first content, which includes an RGB component; and displays, in a second direction, second content which has luminance having a positive correlation with either the R value or the G value of the RGB component.

### TECHNICAL FIELD

The present disclosure relates to a display medium, a processing apparatus, a processing method, and a program.

### BACKGROUND

Humans can perceive colors through red cones, green cones, and blue cones that are three color-sensing cells. On the other hand, the absence or non-functioning of any of the cones may result in minority color vision. Generally, people with minority color vision have difficulty recognizing red and/or green colors. For example, when there is green text on a red background or when there is red text on a green background, a person with minority color vision may not be able to recognize the text at all.

In light of this situation, universal design, which uses colors that are easy to see regardless of whether a person has minority color vision, has become widespread. Universal design has several guidelines, such as not using red and green, which are difficult for people with minority color vision to see.

In addition, display media that display different contents in a plurality of directions are known (see PTLs 1 to 3).

### PATENT LITERATURE

PTL 1: Japanese Patent No. 6374625
PTL 2: Japanese Patent No. 6758447
PTL 3: Japanese Patent No. 6764990

### SUMMARY

However, in universal design, since the available colors are limited, the content cannot be expressed in arbitrary colors.

Since the content expressed in arbitrary colors is difficult for people with minority color vision to see, it is conceivable to write both the content expressed in arbitrary colors for normal people and the content expressed in colors suitable for people with minority color vision. However, a large space is required to write the same content with different color variations.

The present disclosure has been made in view of the above circumstances, and it is an object of the present disclosure to provide a technique capable of displaying the content that is space-saving and easy to see for both normal people and people with minority color vision.

A display medium according to an aspect of the present disclosure is a display medium for displaying contents visually recognizable by normal people and people with minority color vision. A first content including RGB components is displayed in a first direction, and a second content having a brightness that has a positive correlation with either a value of R or a value of G of the RGB components is displayed in a second direction.

A processing apparatus according to an aspect of the present disclosure is a processing apparatus for assigning a color to a color region in a display medium including an upper surface layer formed of a transparent member, having a plurality of upper surface cells, and having a color region in each of the plurality of upper surface cells and a lower surface layer formed of a transparent member, having a plurality of lower surface cells, and having a color region in each of the plurality of lower surface cells. The processing apparatus includes: a calculation unit that calculates each value of RGB of a color to be displayed in each cell for a content to be displayed in a first direction; and an assignment unit that assigns a color to each pixel of the upper surface cell and the lower surface cell so that for each cell, a color of each calculated value of RGB is displayed in the first direction and a color having a brightness that has a positive correlation with either one of an R value and a G value is displayed in a second direction. Cells including the upper surface cells of the upper surface layer and the lower surface cells of the lower surface layer overlapping the upper surface cells are formed so that, when viewed from each of the first and second directions, portions of the color regions of the lower surface cells overlapping the color regions of the upper surface cells are different from each other. Each of the upper surface cells and the lower surface cells has the color region and a transparent region to which no color is given. The color region is provided at a position away from an end of each of the upper surface cells and the lower surface cells, and includes a plurality of pixels.

A processing method according to an aspect of the present disclosure is a processing method for assigning a color to a color region in a display medium including an upper surface layer formed of a transparent member, having a plurality of upper surface cells, and having a color region in each of the plurality of upper surface cells and a lower surface layer formed of a transparent member, having a plurality of lower surface cells, and having a color region in each of the plurality of lower surface cells. The processing method includes: calculating each value of RGB of a color to be displayed in each cell, for a content to be displayed in a first direction, using a computer; and assigning a color to each pixel of the upper surface cell and the lower surface cell using the computer so that for each cell, a color of each calculated value of RGB is displayed in the first direction and a color having a brightness that has a positive correlation with either one of an R value and a G value is displayed in a second direction. Cells including the upper surface cells of the upper surface layer and the lower surface cells of the lower surface layer overlapping the upper surface cells are formed so that, when viewed from each of the first and second directions, portions of the color regions of the lower surface cells overlapping the color regions of the upper surface cells are different from each other. Each of the upper surface cells and the lower surface cells has the color region and a transparent region to which no color is given. The color region is provided at a position away from an end of each of the upper surface cells and the lower surface cells, and includes a plurality of pixels.

A display medium according to an aspect of the present disclosure is a display medium for displaying contents visually recognizable by normal people and people with minority color vision. A first content including RGB components is displayed in a first direction, a second content having a brightness that has a positive correlation with a value of R of the RGB components is displayed in a second direction, and a third content having a brightness that has a positive correlation with a value of G of the RGB components is displayed in a third direction.

A processing apparatus according to an aspect of the present disclosure is a processing apparatus for assigning a color to a color region in a display medium including an upper surface layer formed of a transparent member, having a plurality of upper surface cells, and having a color region in each of the plurality of upper surface cells and a lower surface layer formed of a transparent member, having a plurality of lower surface cells, and having a color region in each of the plurality of lower surface cells. The processing apparatus includes: a calculation unit that calculates each value of RGB of a color to be displayed in each cell for a content to be displayed in a first direction; and an assignment unit that assigns a color to each pixel of the upper surface cell and the lower surface cell so that for each cell, a color of each calculated value of RGB is displayed in the first direction, a color having a brightness that has a positive correlation with the calculated R value is displayed in a second direction, and a color having a brightness that has a positive correlation with the calculated G value is displayed in a third direction. Cells including the upper surface cells of the upper surface layer and the lower surface cells of the lower surface layer overlapping the upper surface cells are formed so that, when viewed from each of the first to third directions, portions of the color regions of the lower surface cells overlapping the color regions of the upper surface cells are different from each other. Each of the upper surface cells and the lower surface cells has the color region and a transparent region to which no color is given. The color region is provided at a position away from an end of each of the upper surface cells and the lower surface cells, and includes a plurality of pixels.

A processing method according to an aspect of the present disclosure is a processing method for assigning a color to a color region in a display medium including an upper surface layer formed of a transparent member, having a plurality of upper surface cells, and having a color region in each of the plurality of upper surface cells and a lower surface layer formed of a transparent member, having a plurality of lower surface cells, and having a color region in each of the plurality of lower surface cells. The processing method includes: calculating each value of RGB of a color to be displayed in each cell, for a content to be displayed in a first direction, using a computer; and assigning a color to each pixel of the upper surface cell and the lower surface cell using the computer so that for each cell, a color of each calculated value of RGB is displayed in the first direction, a color having a brightness that has a positive correlation with the calculated R value is displayed in a second direction, and a color having a brightness that has a positive correlation with the calculated G value is displayed in a third direction. Cells including the upper surface cells of the upper surface layer and the lower surface cells of the lower surface layer overlapping the upper surface cells are formed so that, when viewed from each of the first to third directions, portions of the color regions of the lower surface cells overlapping the color regions of the upper surface cells are different from each other. Each of the upper surface cells and the lower surface cells has the color region and a transparent region to which no color is given. The color region is provided at a position away from an end of each of the upper surface cells and the lower surface cells, and includes a plurality of pixels.

An aspect of the present disclosure is a program for causing a computer to function as the processing apparatus described above.

According to the present disclosure, it is possible to provide a technique capable of displaying content that is space-saving and easy to see for both normal people and people with minority color vision.

### BRIEF DESCRIPTION OF DRAWINGS

FIG. 1 is a perspective view of a display medium according to a first embodiment.

FIG. 2 is a side view of the display medium according to the first embodiment.

FIG. 3 is a diagram illustrating an upper surface layer and a lower surface layer of the display medium according to the first embodiment.

FIG. 4 is a side view of a cell according to the first embodiment.

FIG. 5 is a diagram illustrating functional blocks of a processing apparatus that generates output data for manufacturing the display medium according to the first embodiment.

FIG. 6 is a flowchart illustrating a process for determining colors to be assigned to the display medium according to the first embodiment.

FIG. 7 is a perspective view of a display medium according to a second embodiment.

FIG. 8 is a diagram illustrating an example of a cell of the display medium according to the second embodiment.

FIG. 9 is a diagram illustrating an example of shielded pixels and exposed pixels in the display medium according to the second embodiment.

FIG. 10 is a diagram illustrating functional blocks of a processing apparatus that generates output data for manufacturing the display medium according to the second embodiment.

FIG. 11 is a perspective view of a display medium according to a third embodiment.

FIG. 12(a) is a front view of a partition used in the display medium according to the third embodiment, and FIG. 12(b) is a right side view thereof.

FIG. 13 is a cross-sectional view of a partition used in the display medium according to the third embodiment.

FIG. 14 is a diagram illustrating the hardware configuration of a computer used in a processing apparatus.

### DETAILED DESCRIPTION

Hereinafter, embodiments of the present disclosure will be described with reference to the diagrams. In the diagrams, the same portions are denoted by the same reference numerals, and the descriptions thereof will be omitted.

### Display Medium

A display medium according to an embodiment of the present disclosure displays the content that is visually recognizable by normal people and people with minority color vision. The display medium displays the content, which is easy to be visually recognized by normal people and people with minority color vision, in different directions.

People with minority color vision are people who see or perceive colors differently from the majority of normal people, and are sometimes medically referred to as color blind, color weak, or color vision deficiency. Most people have three types of cones for perceiving colors. People with minority color vision have a deficiency in a specific one or more of the three types of cones, and accordingly have color vision that is different from that of most other people.

In the present disclosure, a display medium displays a first content including RGB components in a first direction. The display medium displays a second content having a brightness, which has a positive correlation with the value of R of the RGB components, in a second direction. The display medium displays a third content having a brightness, which has a positive correlation with the value of G of the RGB components, in a third direction.

The display surface of the display medium is divided into a plurality of cells. Each cell has a plurality of pixels. The content displayed by the display medium according to the embodiment of the present disclosure is expressed by colors assigned to each of a plurality of pixels on the display medium.

The display medium displays the first content, which can be expressed in three primary colors of RGB (Red, Green, Blue), with pixels that are visible from a first viewpoint among the plurality of pixels. The display medium displays the second content having a brightness, which has a positive correlation with the value of a red color component of the first content, with pixels that are visible from a second viewpoint among the plurality of pixels. The display medium displays the third content having a brightness, which has a positive correlation with the value of a green color component of the first content, with pixels that are visible from a third viewpoint among the plurality of pixels.

In the present disclosure, a normal person understands the composition of the content from the red, green and blue components of the first content. A person with minority color vision has difficulty recognizing red or green, and can therefore understand the composition of the content expressed by the blue component of red, green, and blue from the blue component of red, green, and blue of each cell of the first content. On the other hand, the person with minority color vision cannot understand the composition of the content expressed by each of the red and green components even if the person with minority color vision visually recognizes the first content. Therefore, the person with minority color vision understands the composition of the content expressed by the red component from the difference in brightness of each cell of the second content using the display medium according to the present disclosure. The person with minority color vision understands the composition of the content expressed by the green component from the difference in brightness component of each cell of the third content. The person with minority color vision can visually recognize the composition expressed by each color component from the first content, the second content, and the third content by repeating the display medium while changing the viewpoint. Here, the composition of the content is the contours (edges) of the subject or background in the content.

A processing apparatus used to manufacture the display medium according to the embodiment of the present disclosure specifies the color to be applied to each pixel of the display medium as output data that is input to a manufacturing apparatus for manufacturing the display medium, such as a printer.

The processing apparatus includes a calculation unit and an assignment unit.

The calculation unit calculates each value of red, green, and blue of a color to be displayed in a predetermined cell in the first content that can be expressed using the three primary colors of red, green, and blue. Here, the first content only needs to be convertible into the three primary colors of red, green, and blue, and may be formed in a red, green, and blue color model or may be formed in another color model such as CMYK. CMYK stands for Cyan, Magenta, Yellow, and black.

The assignment unit assigns a color to each pixel in a predetermined cell so that pixels visible from the first viewpoint in a predetermined cell display the color of each value of red, green, and blue, pixels visible from the second viewpoint in the predetermined cell display a brightness having a positive correlation with the red value of red, green, and blue, and pixels visible from the third viewpoint in the predetermined cell display a brightness having a positive correlation with the green value of red, green, and blue.

The inventors have obtained the knowledge that people with minority color vision can grasp the composition in the content and understand the content by viewing the content in which red or green has been converted into brightness even though people with minority color vision have difficulty recognizing red or green. In addition, the inventors have obtained the knowledge that many people with minority color vision can grasp the composition in the content by displaying the content in which red and green have been converted into brightness even though there are a plurality of types of minority color vision.

Each display medium disclosed in Patent Literatures and the like can display a plurality of different contents in a plurality of directions. The display medium displays the content, which is easy to be visually recognized by normal people, in a certain direction. In addition, the display medium displays the content for people with minority color vision in the other two directions. The content for people with minority color vision is a content obtained by converting elements, which are difficult for people with minority color vision to visually recognize in a content that is easy to be visually recognized by normal people, into elements that are easy to be visually recognized by people with minority color vision. The content that is easy to be visually recognized by normal people is a content in which each cell is formed in RGB. The content converted into elements that are easy to be visually recognized by people with minority color vision is a content in which the shade of red in each cell has been converted into the intensity of brightness and a content in which the shade of green in each cell has been converted into the intensity of brightness.

People with minority color vision view the three contents in sequence repeatedly by switching the viewing direction of the display medium or by switching the direction of the display medium. People with minority color vision can grasp the composition of the content, specifically, differences in the shades of each color, from the content in which the shade of red is expressed by the intensity of brightness and the content in which the shade of green is expressed by the intensity of brightness.

Such a display medium can display the content that is space-saving and easy to see for both normal people and people with minority color vision.

In addition, since the second and third contents displayed on the display medium are generated reflecting the shade of each color component of the content formed in RGB, the composition in the content appears at the same position on the display medium. By switching the viewing direction of the display medium or by switching the direction of the display medium, it is possible to recognize the shade of red or the shade of green as the intensity of brightness at the same position. The display medium, combined with the afterimage of the intensity of brightness, makes it possible to grasp the composition of the content.

In addition, first to third embodiments will be described as specific examples of a display medium that displays the content that is space-saving and easy to see for both normal people and people with minority color vision, as described in the embodiments of the present disclosure. Here, the display medium will be described by way of three embodiments, but is not limited thereto. In a display medium capable of displaying different contents in different directions, a content formed in RGB (red, green, blue) which is easy for normal people to see, a content in which red has been converted into brightness, and a content in which green has been converted into brightness may be displayed.

### First Embodiment

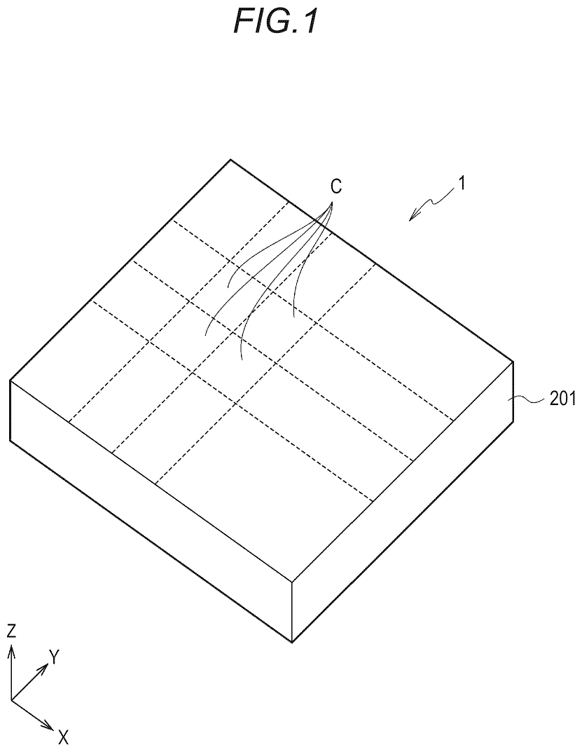

A display medium 1 according to the first embodiment will be described with reference to FIG. 1. The display medium 1 according to the first embodiment has the configuration of the display medium described in PTL 2. As shown in FIG. 1, the display medium 1 has a plurality of cells C on its surface. In the example shown in FIG. 1, the user's line of sight is upward in the Z-axis direction. In the example shown in FIG. 1, the display medium 1 has a rectangular parallelepiped shape, but the shape does not matter. The display medium 1 may be formed in a sheet shape, or may be formed in a three-dimensional shape.

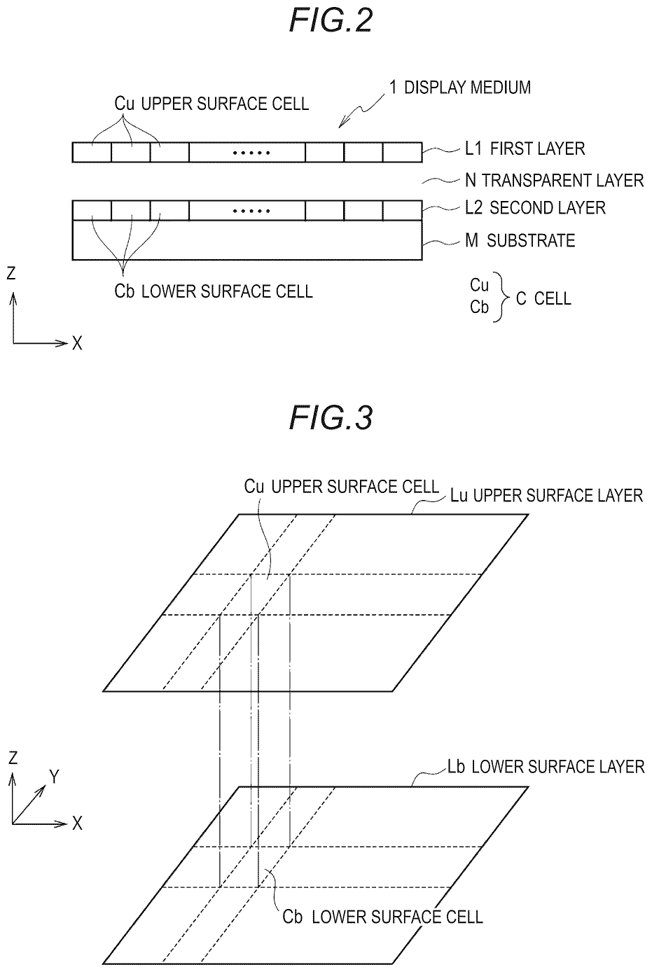

As shown in FIG. 2, the display medium 1 has an upper surface layer Lu and a lower surface layer Lb. The names of the upper surface layer Lu and the lower surface layer Lb do not depend on the arrangement of the display medium 1. In the first embodiment, a layer closer to the user's viewpoint is referred to as the upper surface layer Lu. A layer far from the user's viewpoint is referred to as the lower surface layer Lb.

As shown in FIGS. 2 and 3, the upper surface layer Lu and the lower surface layer Lb are formed on the XY plane and are arranged in parallel to the Z-axis direction. The display medium 1 displays a plurality of contents corresponding to a plurality of directions based on portions through which light components in a plurality of directions pass through the upper surface layer Lu and the lower surface layer Lb. Each content is visually recognized at each viewpoint provided at positions where light components in a plurality of directions that have passed through the upper surface layer Lu and the lower surface layer Lb are incident. The display medium 1 displays a plurality of contents because the combination of the color of a portion passing through the upper surface layer Lu and the color of a portion passing through the lower surface layer Lb differs for each direction. The display medium 1 displays contents at three different viewpoints upward in the Z-axis direction on the upper surface layer Lu and the lower surface layer Lb. The three different viewpoints have at least different values in the X and Y values.

In the first embodiment, light in a predetermined direction used when displaying the content is emitted from a direction opposite to the viewpoint at least for the upper surface layer Lu and the lower surface layer Lb. When the viewpoint is located above the upper surface layer Lu and the lower surface layer Lb in the Z-axis direction, light needs only to be emitted from below the upper surface layer Lu and the lower surface layer Lb in the Z-axis direction, and the position of the light source does not matter. The light traveling from below to above the lower surface layer Lb in the Z-axis direction may be, for example, light from a light source provided at an arbitrary position and reflected by a substrate M or may be light from a light source provided on the substrate M.

As shown in FIG. 2, a transparent layer N is formed between the upper surface layer Lu and the lower surface layer Lb. In addition, the substrate M is provided on the lower surface layer Lb in a direction opposite to the transparent layer N in the Z-axis direction. The display medium 1 is formed by stacking the substrate M, the lower surface layer Lb, the transparent layer N, and the upper surface layer Lu in this order in the Z-axis direction.

It is preferable that the transparent layer N is formed of a material that does not absorb the color components of light and transmits a large amount of light. The transparent layer N is formed of a transparent material such as water or transparent plastic. The transparent layer N may be formed of air. In other words, the upper surface layer Lu and the lower surface layer Lb may be arranged in parallel with each other at a predetermined distance apart. The substrate M is formed of a member such as a mirror or white paper that allows the colors applied to the upper surface layer Lu and the lower surface layer Lb to be easily visually recognized.

As shown in FIGS. 2 and 3, the upper surface layer Lu is formed of a transparent member and has a plurality of upper surface cells Cu. Each of the plurality of upper surface cells Cu has a color region. The lower surface layer Lb is formed of a transparent member and has a plurality of lower surface cells Cb. Each of the plurality of lower surface cells Cb has a color region. With a predetermined definition of the respective positions of the upper surface cell Cu and the lower surface cell Cb, a printer and the like that applies color to the color regions of the upper surface cell Cu and the lower surface cell Cb needs only to be able to specify the position of each color region, and the respective positions of the upper surface cell Cu and the lower surface cell Cb do not need to be visually recognized. For example, there may be no separations, such as clear lines, partitions, and recesses, between two adjacent upper surface cells Cu or two adjacent lower surface cells Cb. The two adjacent upper surface cells Cu or the two adjacent lower surface cells Cb do not have to be physically separated from each other. In addition, at the boundary between the two adjacent upper surface cells Cu or the two lower surface cells Cb, the ends of the two cells may be given the same color or the same colorlessness so that the adjacent cells C are not visually recognizable.

In the first embodiment, each upper surface cell Cu of the upper surface layer Lu and each lower surface cell Cb of the lower surface layer Lb are formed by dividing each layer in the same manner. Each upper surface cell Cu of the upper surface layer Lu is formed at a position shifted in the Z-axis direction from each lower surface cell Cb of the lower surface layer Lb. More specifically, as shown in FIG. 3, in the embodiment of the present invention, the upper surface cell Cu of the upper surface layer Lu is formed at a position shifted in the Z-axis direction from the lower surface cell Cb of the lower surface layer Lb. The same is true for the other cells. In the first embodiment, the relationship between cells formed at positions shifted in the Z-axis direction, such as the upper surface cell Cu and the lower surface cell Cb, is referred to as “corresponding”.

In the first embodiment, a cell C includes the upper surface cell Cu of the upper surface layer Lu and the lower surface cell Cb of the lower surface layer Lb overlapping the upper surface cell Cu. The cell C is specified by a combination of the upper surface cell Cu and the lower surface cell Cb corresponding to each other among the upper surface cells Cu of the upper surface layer Lu and the lower surface cells Cb of the lower surface layer Lb.

As shown in FIGS. 2 to 4, the upper surface layer Lu is formed of a transparent member and has a plurality of upper surface cells Cu. Each of the plurality of upper surface cells Cu has color regions G11 and G12. The lower surface layer Lb is formed of a transparent member and has a plurality of lower surface cells Cb. Each of the plurality of lower surface cells Cb has color regions G21, G22, G23, G24, G25, and G26. Each of the color regions G11, G12, G21, G22, G23, G24, G25, and G26 is formed by one or more pixels. Here, a pixel is a unit to which a manufacturing apparatus for the display medium 1 gives the same color.

In the first embodiment, a case has been described in each of the upper surface cells Cu and each of the lower surface cells Cb have color regions with the same shape. However, the shape may differ for each of the upper surface cells Cu and the lower surface cells Cb. In the first embodiment, a case has been described in which a plurality of color regions are provided in the X-axis direction in each of the upper surface layer Lu and the lower surface layer Lb. However, a single color region may be provided. In addition, a case where one color region is provided in the Y-axis direction has been described, but a plurality of color regions may be provided. In addition, a case where a plurality of color regions are provided adjacent to each other has been described, but a plurality of color regions may be provided discretely. For example, a transparent region may be provided between a plurality of color regions.

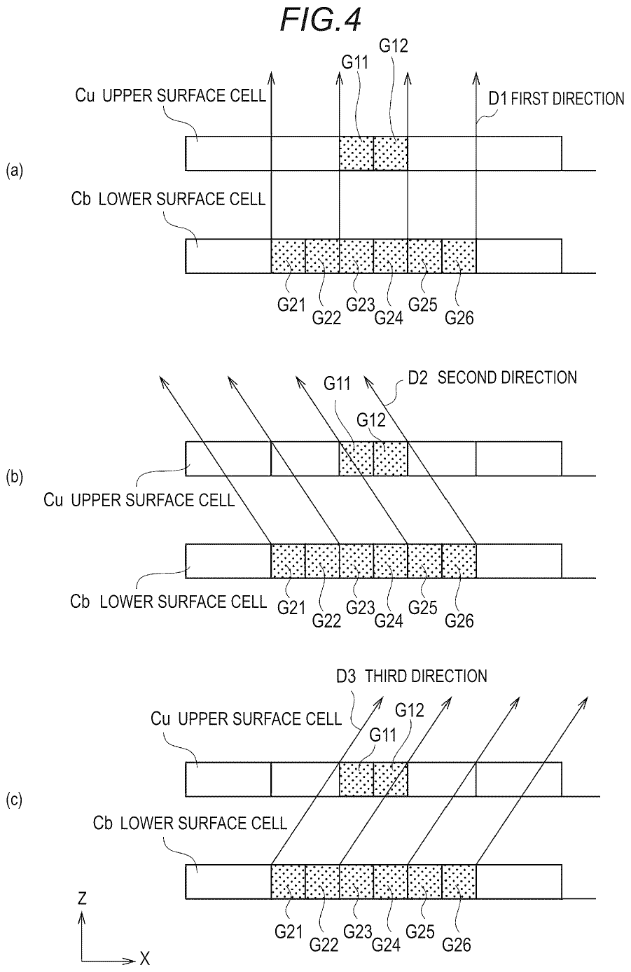

The upper surface cell Cu and the lower surface cell Cb that form one cell will be described with reference to FIG. 4. In the first embodiment, a transparent region is provided at the boundary between each upper surface cell Cu and each lower surface cell Cb. A color region is provided in a portion further inward than the transparent region. By providing a transparent region, it is possible to form a color region so that light passing through the color region does not pass through a color region of an adjacent cell, thereby reducing the burden of calculating the colors to be assigned to each color region. The color region is formed by applying ink to each layer. The ink may be a dye ink or may be a pigment ink. In addition, in FIG. 4, a non-hatched portion is a transparent portion where ink does not adhere. One color region is formed by one or more pixels. In the present disclosure, one color is uniformly applied within one color region G11. The same is true for the other color regions G12 to G26.

In one cell, the positions of the upper surface cell Cu and the lower surface cell Cb are set such that light passing through the color region of the upper surface cell Cu passes through the lower surface cell Cb and light passing through the color region of the lower surface cell Cb passes through the upper surface cell Cu. In the first embodiment, a case has been described in which the upper surface cell Cu and the lower surface cell Cb included in one cell are shifted from each other in the Z-axis direction, but the invention is not limited to this. The upper surface cell Cu and the lower surface cell Cb corresponding to each other may be shifted from each other in an oblique direction, specifically, may be shifted from each other not only in the Z-axis direction but also in the X-axis direction or Y-axis direction.

In the first embodiment, the cells are formed such that when viewed from each of the first to third directions, the portions of the color region of the lower surface cell Cb that overlap the color region of the upper surface cell Cu are different from each other. In this manner, the cells can display different colors in the first to third directions. Here, “different from each other” means not completely the same, and includes not only cases of completely different, but also cases of at least partially the same and partially different.

For example, in the first direction in FIG. 4(a), the color regions G11 and G12 of the upper surface cell Cu overlap the color regions G23 and G24 of the lower surface cell Cb. In the second direction in FIG. 4(b), the color regions G11 and G12 of the upper surface cell Cu overlap the color regions G25 and G26 of the lower surface cell Cb. In the third direction in FIG. 4C, the color regions G11 and G12 of the upper surface cell Cu overlap the color regions G21 and G22 of the lower surface cell Cb.

In the example shown in FIG. 4, a case has been described in which, the color regions of the lower surface cell Cb that overlap the color region of the upper surface cell Cu in the first to third directions do not completely overlap each other, but partial overlap is also acceptable. For example, in another embodiment, the color regions G23 and G24 overlap the color region of the upper surface cell Cu in the first direction. The color regions G24 and G25 may overlap the color region of the upper surface cell Cu in the second direction, and the color regions G22 and G23 may overlap the color region of the upper surface cell Cu in the third direction.

In addition, when the ink used in each color region is a highly transparent ink such as dye ink, the user can visually recognize a mixture of the colors of color regions overlapping each other at each viewpoint in each viewing direction. In FIG. 4(a), the user visually recognizes a mixture of the colors of G11 and G23 and a mixture of the colors of G12 and G24. In addition, the user visually recognizes a mixture of the colors of G11 and G23, a mixture of the colors of G12 and G24, and a mixture of the colors of G21, G22, G25, and G26 through juxtaposition additive color mixing.

On the other hand, when the ink used in each color region is an ink with low transparency such as pigment ink, the user can visually recognize a color close to the viewpoint in the viewing direction. In FIG. 4(a), the user visually recognizes the color of G11 and the color of G12. In addition, the user visually recognizes a mixture of the colors of G11 and G12 and a mixture of the colors of G21, G22, G25, and G26 through juxtaposition additive color mixing.

Thus, in each cell of the display medium 1 according to the first embodiment, a portion of the color region of the lower surface cell Cb that overlaps the color region of the upper surface cell Cu differs in the first direction, the second direction, and the third direction. For this reason, it is possible to display different contents in the three directions.

Specifically, the display medium 1 displays the first content including RGB components in the first direction. The display medium 1 displays the second content having a brightness, which has a positive correlation with the value of R of the RGB components, in the second direction. The display medium 1 displays the third content having a brightness, which has a positive correlation with the value of G of the RGB components, in the third direction. In addition, the display medium 1 is only required to be able to display three contents in three different directions, and the three directions are not limited to those shown in FIG. 4.

Here, the ratio of the R value to the range of R of the RGB components of the first content may correspond to the ratio of the brightness value to the range of the brightness of the second content. Similarly, the ratio of the G value to the range of G of the RGB components of the first content may correspond to the ratio of the brightness value to the range of the brightness of the third content. For example, when each value of the RGB components in the first content is expressed in 256 levels and the brightness in the second content and the third content is expressed in 256 levels, it is preferable that the value of R of the RGB components of the first content is the same as the brightness value of the second content. It is preferable that the value of G of the RGB components of the first content is the same as the brightness value of the third content. In addition, from the viewpoint of viewability, the brightness in the second content may be a predetermined multiple of the R value in the first content, or an offset may be applied. Similarly, the brightness in the third content may be a predetermined multiple of the G value in the first content, or an offset may be applied.

The display medium 1 displays the second content in which the shade of the R component has been converted into the intensity of brightness and the third content in which the shade of the G component has been converted into the intensity of brightness in addition to the first content that can be converted into each of the RGB components. Normal people view the first content. People with minority color vision due to green or red cone deficiency can visually recognize the composition of the content formed by the B component of the first content, and can visually recognize the composition of the content formed by the R component and the G component by repeatedly viewing the second content and the third content while changing the viewpoint.

In the first embodiment, people with minority color vision can recognize a composition expressed by the shades of RGB by changing the viewpoint for the display medium 1 alternately among a viewpoint from which the first content is viewed, a viewpoint from which the second content is viewed, and a viewpoint from which the third content is viewed, specifically, by changing the viewpoint to the direct upper direction, the left-inclined upward direction, and the right-inclined upward direction with respect to the display medium 1.

### Processing Apparatus

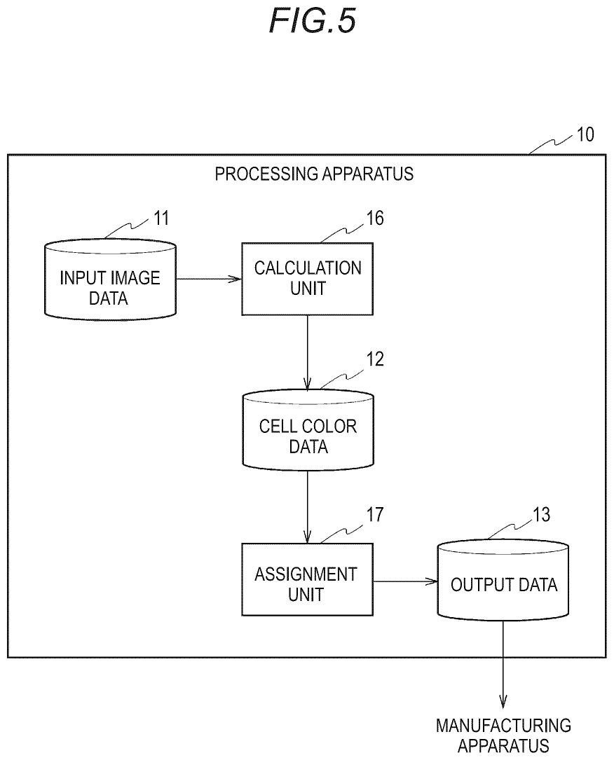

A processing apparatus 10 for determining the color to be applied to the display medium 1 will be described with reference to FIG. 5. The processing apparatus 10 includes input image data 11, cell color data 12, and output data 13, and has functions of a calculation unit 16 and an assignment unit 17. Each piece of data is stored in a storage device such as a memory 902 or a storage 903. Each function is implemented in a CPU 901.

The input image data 11 is an image of the content to be displayed on the display medium 1. The input image data 11 includes a plurality of pixels, and each pixel is associated with a predetermined color. The input image data 11 is the content that is visually recognizable by normal people. The input image data 11 can be converted into each of the RGB components.

The cell color data 12 is data of a color to be expressed in each cell of the display medium 1.

The output data 13 is data that associates the values of colors printed on each layer with their positions when the display medium 1 is formed by the manufacturing apparatus. The output data 13 specifies, for each cell, the color to be applied to each color region of the cell. In the example shown in FIG. 4, the output data 13 associates colors to be applied to each of the color regions G11, G12, G21, G22, G23, G24, G25, and G26 for each cell.

The calculation unit 16 calculates each of the RGB values of the color to be displayed in each cell for the content to be displayed in the first direction. The calculation unit 16 calculates each value of red, green, and blue (RGB) of the color to be displayed in the upper surface cell Cu and the lower surface cell Cb of a certain cell in the first content expressed in RGB. The calculation unit 16 calculates the RGB values of the input image data 11 corresponding to the position of the cell to be processed as RGB values of the color to be displayed by the upper surface cell Cu and the lower surface cell Cb of this pair. The calculation unit 16 calculates RGB values for each cell and outputs the RGB values to the cell color data 12.

The assignment unit 17 determines a color to be assigned to each color region for each cell, and outputs the determined color to the output data 13. The assignment unit 17 assigns a color to each pixel of the upper surface cell Cu and the lower surface cell Cb so that, for each cell, the color of each of the calculated RGB values is displayed in the first direction, a color having a brightness that has a positive correlation with the calculated R value is displayed in the second direction, and a color having a brightness that has a positive correlation with the calculated G value is displayed in the third direction.

The assignment unit 17 assigns a color to each pixel for the cell to be processed so that the ratio of the R value to the range of R of the RGB components of the first content corresponds to the ratio of the brightness value to the range of the brightness of the second content and the ratio of the G value to the range of G of the RGB components of the first content corresponds to the ratio of the brightness value to the range of the brightness of the third content.

The assignment unit 17 searches for the color of each pixel so that, for example, the RGB calculated by the calculation unit 16 is achieved by a combination of each pixel visible from the first direction, a brightness corresponding to the shade of R calculated by the calculation unit 16 is achieved by a combination of each pixel visible from the second direction, and a brightness corresponding to the shade of G calculated by the calculation unit 16 is achieved by a combination of each pixel visible from the third direction. The assignment unit 17 may perform a brute force search or a search by optimization. For example, the assignment unit 17 sets, as targets, RGB values to be displayed in the first direction, a brightness to be displayed in the second direction, and a brightness to be displayed in the third direction. The assignment unit 17 sets, as an evaluation function, a difference between the target and RGB values to be displayed in the first direction realized by the searched color of each pixel, a difference between the target and the brightness to be displayed in the second direction, and a difference between the target and the brightness to be displayed in the third direction. The assignment unit 17 determines the color to be assigned to each pixel so as to minimize the evaluation function.

After determining the color to be assigned to each pixel in each cell, the assignment unit 17 outputs it to the output data 13.

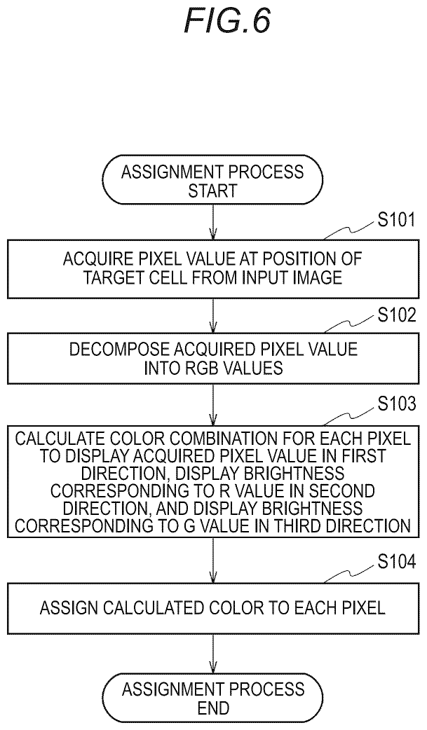

A process of assigning a color to each pixel of a predetermined target cell will be described with reference to FIG. 6.

First, in step S101, the processing apparatus 10 acquires, from the input image data 11, a pixel value at the position of the cell to be processed. In step S102, the processing apparatus 10 decomposes the pixel value acquired in step S101 into RGB values.

In step S103, the processing apparatus 10 calculates a color combination for each pixel to display the acquired pixel value in the first direction, display a brightness corresponding to the R value decomposed in step S102 in the second direction, and display a brightness corresponding to the G value decomposed in step S102 in the third direction.

In step S104, the processing apparatus 10 assigns the calculated color to each pixel of the cell to be processed.

The processing apparatus 10 repeats the process shown in FIG. 6 for each cell. The processing apparatus 10 outputs the correspondence between a pixel and a color in each cell to the output data 13. By inputting the output data 13 to a manufacturing apparatus such as a printer, the upper surface layer Lu and the lower surface layer Lb in which each pixel is colored with an appropriate color are output. The display medium 1 is formed from the substrate M, the lower surface layer Lb, and the third layer.

The display medium 1 according to the first embodiment can display the content that is space-saving and easy to see for both normal people and people with minority color vision. In addition, the display medium 1 according to the first embodiment displays the second content in which the shade of R has been converted into the intensity of brightness and the third content in which the shade of G has been converted into the intensity of brightness, in addition to the content expressed in RGB. The display medium 1 displays the content that is easy to see not only for normal people but also for people with minority color vision who have difficulty recognizing at least one of red and green. The display medium 1 allows a larger number of users to visually recognize the content.

### Modification Example of the First Embodiment

In the first embodiment, a case where three contents are displayed in three directions has been described. However, in a modification example, a case where two contents are displayed in two directions will be described.

The display medium 1 according to the modification example displays a first content including RGB components in the first direction, and displays a second content having a brightness that has a positive correlation with either the R value or the G value of the RGB components in the second direction.

When the brightness of the second content has a positive correlation with the R value, the ratio of the R value to the range of the value of R of the RGB components of the first content corresponds to the ratio of the brightness value to the range of the brightness of the second content. In each cell viewed from the first viewpoint in the first direction, the display medium 1 displays the first content including RGB components in the first direction, and displays the second content, in which the brightness of each cell viewed from the second viewpoint in the second direction has a positive correlation with the value of R of the RGB components corresponding to each cell, in the second direction. The assignment unit 17 of the processing apparatus 10 according to the modification example assigns a color to each pixel of upper surface cells and lower surface cells so that, for each cell, the color of each of the RGB values calculated by the calculation unit 16 is displayed in the first direction and a color having a brightness that has a positive correlation with the R value is displayed in the second direction.

The display medium 1 according to the modification example displays the content in which the shade of R has been converted into the intensity of brightness, as the second content, in addition to the content expressed in RGB as the first content. The display medium 1 displays the content that is easy to see not only for normal people but also for people with minority color vision who have difficulty perceiving red. A person with minority color vision who has difficulty recognizing red can understand the composition of the content expressed by the green and blue components of red, green, and blue from the green and blue components of red, green, and blue of each cell of the first content. A person with minority color vision who has difficulty perceiving red can understand the composition of the content expressed by the red component from the difference in brightness of each cell of the second content.

When the brightness of the second content has a positive correlation with the G value, the ratio of the G value to the range of the value of G of the RGB components of the first content corresponds to the ratio of the brightness value to the range of the brightness of the second content. In each cell viewed from the first viewpoint in the first direction, the display medium 1 displays the first content including RGB components in the first direction, and displays the second content, in which the brightness of each cell viewed from the second viewpoint in the second direction has a positive correlation with the value of G of the RGB components corresponding to each cell, in the second direction. The assignment unit 17 of the processing apparatus 10 according to the modification example assigns a color to each pixel of upper surface cells and lower surface cells so that, for each cell, the color of each of the RGB values calculated by the calculation unit 16 is displayed in the first direction and a color having a brightness that has a positive correlation with the G value is displayed in the second direction.

The display medium 1 according to the modification example displays the content in which the shade of G has been converted into the intensity of brightness, as the second content, in addition to the content expressed in RGB as the first content. The display medium 1 displays the content that is easy to see not only for normal people but also for people with minority color vision who have difficulty perceiving green. A person with minority color vision who has difficulty recognizing green can understand the composition of the content expressed by the red and blue components of red, green, and blue from the red and blue components of red, green, and blue of each cell of the first content. A person with minority color vision who has difficulty perceiving green can understand the composition of the content expressed by the green component from the difference in brightness of each cell of the second content.

The display medium 1 according to the modification example of the first embodiment can display the content that is space-saving and easy to see for both normal people and people with minority color vision.

### Second Embodiment

In the first embodiment, a case has been described in which a display medium is formed using the technique described in PTL 2. In the second embodiment, a case will be described in which a display medium 100 is formed using the technique described in PTL 1.

The display medium 100 according to the second embodiment displays the content that is visually recognizable by normal people and people with minority color vision. The display medium 100 displays three contents corresponding to three azimuth angles from a predetermined elevation angle and azimuth angle.

In the second embodiment, the display medium 100 has a plurality of cells on its surface. A cell C has a protruding member having a light blocking property and a color region on its surface. The cell C is formed so that the color region visually recognized differs when viewed from each of the first to third directions. Here, “color region differs” means not completely the same, and includes not only cases of completely different, but also cases of at least partially the same and partially different. The display medium 100 displays the first content including RGB components in the first direction in each cell viewed from the first viewpoint in the first direction. The first content is formed by each pixel of each cell that is visible from the first viewpoint. The display medium 100 displays the second content, in which the brightness of each cell viewed from the second viewpoint in the second direction has a positive correlation with the value of R of the RGB components corresponding to each cell, in the second direction. The second content is formed by each pixel of each cell that is visible from the second viewpoint. The display medium 100 displays the third content, in which the brightness of each cell viewed from the third viewpoint in the third direction has a positive correlation with the value of G of the RGB components corresponding to each cell, in the third direction. The third content is formed by each pixel of each cell that is visible from the third viewpoint.

The display medium 100 according to the second embodiment can display the content that is space-saving and easy to see for both normal people and people with minority color vision, as in the first embodiment.

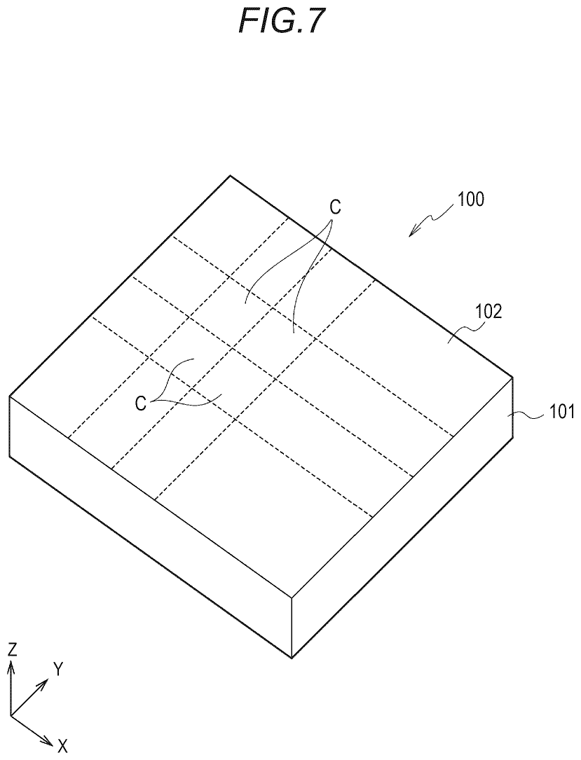

As shown in FIG. 7, the display medium 100 includes a substrate 101 and a colored portion 102 on the upper surface of the substrate 101 that expresses the color of the content. The substrate 101 has a surface that reflects light. The substrate 101 may have a thin sheet shape such as paper, or may have a three-dimensional shape. The upper surface of the substrate 101 may be a flat surface or may be a curved surface.

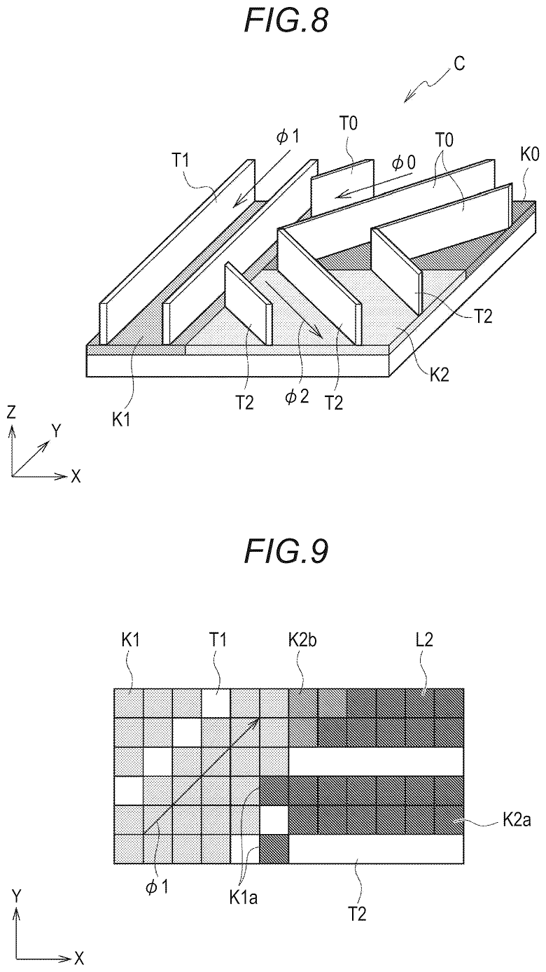

The upper surface of the substrate 101 is divided into a plurality of cells C. The plurality of cells may be provided adjacent to each other, or may be provided so as to be spaced apart from each other. Each of the plurality of cells C is divided into three sub-cells K0, K1, and K2 corresponding to three azimuth angles, as shown in FIG. 8. The sub-cell K0 corresponds to azimuth angle φ0. The sub-cell K1 corresponds to azimuth angle φ1. The sub-cell K2 corresponds to azimuth angle φ2.

In the sub-cells K0, K1, and K2 corresponding to predetermined azimuth angles, protruding members T0, T1, and T2 are formed, respectively. The protruding member T0 is formed in the sub-cell K0. The protruding member T1 is formed in the sub-cell K1. The protruding member T2 is formed in the sub-cell K2.

The protruding members T0, T1, and T2 are formed of a member that blocks light. Each of the protruding members T0, T1, and T2 has a surface in a predetermined azimuth angle direction, more specifically, a surface parallel to the azimuth angle corresponding to the sub-cell in which the protruding member is formed.

From a predetermined elevation angle and azimuth angle, a colored portion of the sub-cell corresponding to the predetermined azimuth angle is observed.

For example, when a user observes a coordinate x on the display medium 100 at a predetermined elevation angle ω0 and azimuth angle φ0, the color value of the coordinate of the first content corresponding to the coordinate x on the display medium 100 can be checked. Similarly, when the user observes the coordinate x on the display medium 100 at a predetermined elevation angle ω1 and azimuth angle φ1, the color value of the coordinate of the second content corresponding to the coordinate x on the display medium 100 can be checked. In addition, when the user observes the coordinate x on the display medium 100 at a predetermined elevation angle ω2 and azimuth angle φ2, the color value of the coordinate of the third content corresponding to the coordinate x on the display medium 100 can be checked.

In the second embodiment, a case will be described in which the first content is displayed at the azimuth angle φ0, the second content is displayed at the azimuth angle φ2, and the third content is displayed at the azimuth angle φ3, but the invention is not limited thereto. The correspondence between the azimuth angle and the content to be displayed is determined appropriately.

The cell C at the coordinate x will be described with reference to FIG. 8. The cell C includes the sub-cells K0, K1, and K2. In the sub-cell K0, three protruding members T0 are arranged in parallel to the direction of the azimuth angle φ0. In the sub-cell K1, two protruding members T1 are arranged in parallel to the direction of the azimuth angle φ1. In the sub-cell K2, three protruding members T2 are arranged in parallel to the direction of the azimuth angle φ2.

The protruding member T has a predetermined height. Therefore, when the display medium 100 is observed from a predetermined elevation angle, there are portions that are blocked by the protruding member T and portions that are not blocked by the protruding members T on the surface of the display medium 100. When observed from the azimuth angle φ0, the user can visually recognize the colored portion 102 of the sub-cell K0 in which the protruding member T0 parallel to the azimuth angle φ0 is formed, but has difficulty visually recognizing the colored portions 102 of the other sub-cells K1 and K2. When observed from the azimuth angle φ1, the user can visually recognize the colored portion 102 of the sub-cell K1 in which the protruding member T1 parallel to the azimuth angle φ1 is formed, but has difficulty visually recognizing the colored portions 102 of the other sub-cells K0 and K2. When observed from the azimuth angle φ2, the user can visually recognize the colored portion 102 of the sub-cell K2 in which the protruding member T2 parallel to the azimuth angle φ2 is formed, but has difficulty visually recognizing the colored portions 102 of the other sub-cells K0 and K1.

Such a display medium 100 according to the second embodiment can display three contents in three directions. The display medium 100 can display the first content including RGB components at the first viewpoint on the azimuth angle φ0, with pixels visible from the first viewpoint. The display medium 100 can display the second content, in which the brightness of each cell has a positive correlation with the value of R of the RGB components corresponding to each cell, at the second viewpoint on the azimuth angle φ1, with pixels visible from the second viewpoint. The display medium 100 can display the third content, in which the brightness of each cell has a positive correlation with the value of G of the RGB components corresponding to each cell, at the third viewpoint on the azimuth angle φ2, with pixels visible from the third viewpoint.

In addition, in the second embodiment, it is ideal that, when viewed from a predetermined azimuth angle, the user can check each pixel of the colored portion 102 of a sub-cell corresponding to the azimuth angle but cannot check each pixel of the colored portion 102 of a sub-cell that does not correspond to the azimuth angle. However, this may not always be the case.

A case is considered in which the protruding member T1 is formed in the sub-cell K1 as shown in FIG. 9. When the user observes from a direction of φ1 parallel to the protruding member T1, almost all the pixels in the sub-cell K1 can be checked. However, a shielded portion K1a, which is an unobserved pixel, is formed in the sub-cell K1. In addition, an exposed portion K2b, which is an observed pixel, may be formed in the sub-cell K2 that does not correspond to the azimuth angle φ1. Therefore, in the processing of an assignment unit 117 described below, a group of pixels visible for each viewpoint is specified, and a color is assigned to the specified group of pixels so as to be displayed at that viewpoint.

Next, a processing apparatus 110, which assigns a color to each pixel of the display medium 100, will be described.

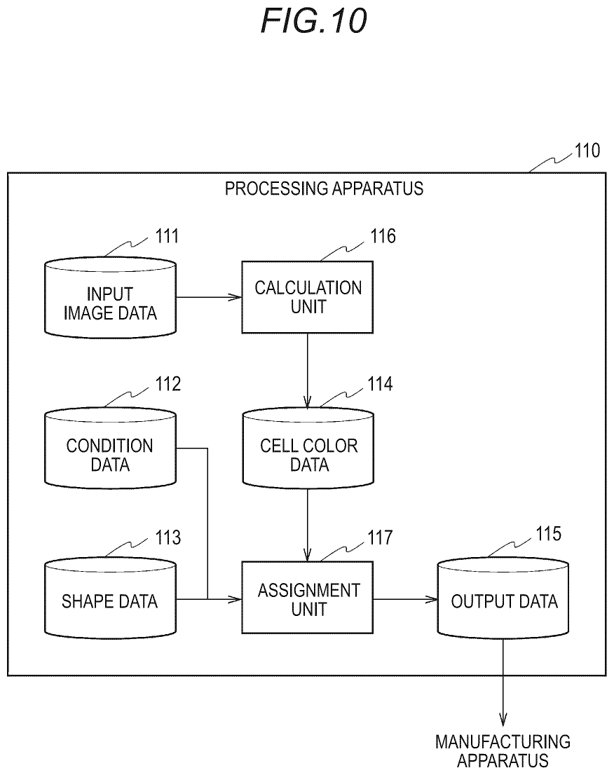

As shown in FIG. 10, the processing apparatus 110 includes input image data 111, condition data 112, shape data 113, cell color data 114, and output data 115, and has functions of a calculation unit 116 and the assignment unit 117. Each piece of data is stored in a storage device such as the memory 902 or the storage 903. Each function is implemented in the CPU 901.

The input image data 111, the cell color data 114, and the output data 115 are similar to the input image data 11, the cell color data 12, and the output data 13 in FIG. 6. The processing of the calculation unit 116 is similar to the processing of the calculation unit 16 in FIG. 6.

The condition data 112 is data that specifies an azimuth angle and an elevation angle at which the content is displayed on the display medium 100. The shape data 113 is data that specifies the positions and heights of protruding members arranged in each sub-cell of the display medium 100.

The assignment unit 117 assigns a color to each pixel in a cell to be processed so that pixels visible from the first viewpoint in the cell to be processed display a color including RGB components, pixels visible from the second viewpoint in the cell to be processed display a color having a brightness that has a positive correlation with the value of R of the RGB components, and pixels visible from the third viewpoint in the cell to be processed display a color having a brightness that has a positive correlation with the value of G of the RGB components. The pixels to which colors are assigned herein are pixels where no protruding members are formed among the pixels in the cell to be processed.

The assignment unit 117 specifies, among the pixels in the cell to be processed, a group of pixels visible from the first viewpoint, a group of pixels visible from the second viewpoint, and a group of pixels visible from the third viewpoint. For example, in the example of FIG. 9, pixels visible when viewed from the azimuth angle φ1 include the exposed portion K2b in the sub-cell K2, but does not include the shielded portion K1a in the sub-cell K1.

The assignment unit 117 assigns a color to each pixel in each pixel group so that RGB values to be expressed in the cell to be processed, a brightness corresponding to the value of red among RGB, and a brightness corresponding to the green value can be expressed.

The processing apparatus 110 repeats the process of assigning a color to each pixel for each cell, and outputs the correspondence between a pixel and a color in each cell to the output data 115. The output data 115 is input to a manufacturing apparatus such as a printer, and the display medium 100 in which each pixel is colored with an appropriate color is output. The printer may be a 3D printer that can also form a protruding member.

The display medium 100 according to the second embodiment can display the content that is space-saving and easy to see for both normal people and people with minority color vision, similarly to the display medium 1 according to the first embodiment.

### Technique A

A display medium capable of displaying three contents corresponding to three azimuth angles for a predetermined elevation angle and the three azimuth angles, the display medium including:
a substrate that reflects light,
wherein the substrate is divided into a plurality of cells,
each of the plurality of cells is divided into three sub-cells corresponding to the three azimuth angles,
a protruding member having a surface in a direction of the predetermined azimuth angle and blocking light is formed in each sub-cell corresponding to the predetermined azimuth angle,
a sub-cell corresponding to the predetermined azimuth angle is observed from the predetermined elevation angle and azimuth angle,
a first content including RGB components is displayed with pixels visible from a first viewpoint among the plurality of pixels, a second content in which the brightness of each cell has a positive correlation with a value of R of the RGB components corresponding to each cell is displayed with pixels visible from a second viewpoint among the plurality of pixels, and a third content in which the brightness of each cell has a positive correlation with a value of G of the RGB components corresponding to each cell is displayed with pixels visible from a third viewpoint among the plurality of pixels, and
people with minority color vision can visually recognize the composition of the content by repeatedly viewing the first content, the second content, and the third content while changing the viewpoint.

### Technique B

A processing apparatus for assigning a color to each pixel of the display medium described in Technique A,
wherein the display medium includes a plurality of cells, and
the processing apparatus includes:
a calculation unit that calculates each value of red, green, and blue of a color to be displayed in a predetermined cell in the first content; and
an assignment unit that assigns a color to each pixel in the predetermined cell so that pixels visible from the first viewpoint in the predetermined cell display a color including RGB components, pixels visible from the second viewpoint in the predetermined cell display a color having a brightness that has a positive correlation with a value of R of the RGB components, and pixels visible from the third viewpoint in the predetermined cell display a color having a brightness that has a positive correlation with a value of G of the RGB components.

### Modification Example of the Second Embodiment

In the second embodiment, a case where three contents are displayed in three directions has been described. However, in a modification example, a case where two contents are displayed in two directions will be described. The display medium 100 according to the modification example of the second embodiment displays the first content including RGB components in the first direction and displays the second content having a brightness, which has a positive correlation with either the value of R or the value of G of the RGB components, in the second direction, similarly to the display medium 1 according to the modification example of the first embodiment.

When the brightness of the second content has a positive correlation with the value of R, the display medium 100 displays the first content including RGB components with pixels visible from the first viewpoint among a plurality of pixels, and displays the second content, in which the brightness of each cell has a positive correlation with the value of R of the RGB components corresponding to each cell, with pixels visible from the second viewpoint among the plurality of pixels. The assignment unit 117 of the processing apparatus 110 assigns a color to each pixel in a predetermined cell so that pixels visible from the first viewpoint in the predetermined cell display a color including RGB components and pixels visible from the second viewpoint in the predetermined cell display a color having a brightness that has a positive correlation with the value of R of the RGB components. The display medium 100 displays the content that is easy to see not only for normal people but also for people with minority color vision who have difficulty perceiving red.

When the brightness of the second content has a positive correlation with the value of G, the display medium 100 displays the first content including RGB components with pixels visible from the first viewpoint among a plurality of pixels, and displays the second content, in which the brightness of each cell has a positive correlation with the value of G of the RGB components corresponding to each cell, with pixels visible from the second viewpoint among the plurality of pixels. The assignment unit 117 of the processing apparatus 110 assigns a color to each pixel in a predetermined cell so that pixels visible from the first viewpoint in the predetermined cell display a color including RGB components and pixels visible from the second viewpoint in the predetermined cell display a color having a brightness that has a positive correlation with the value of G of the RGB components. The display medium 100 displays the content that is easy to see not only for normal people but also for people with minority color vision who have difficulty perceiving green.

The display medium 100 according to the modification example of the second embodiment can display the content that is space-saving and easy to see for both normal people and people with minority color vision.

### Third Embodiment

In the first embodiment, a case has been described in which a display medium is formed using the technique described in PTL 2. In the second embodiment, a case will be described in which a display medium 200 is formed using the technique described in PTL 3.

The display medium 200 according to the third embodiment displays the content that is visually recognizable by normal people and people with minority color vision. The display medium 200 displays three contents corresponding to three azimuth angles from a predetermined elevation angle and azimuth angle.

In the third embodiment, the display medium 200 has a plurality of cells on its surface. The cell has a partition that radially divides the space on the cell C in three directions and has a color region. The cell C is formed so that the color region visually recognized differs when viewed from each of the first to third directions. Here, “color region differs” means not completely the same, and includes not only cases of completely different, but also cases of at least partially the same and partially different. The display medium 200 displays the first content including RGB components in the first direction in each cell viewed from the first viewpoint in the first direction. The first content is formed by each pixel of each cell that is visible from the first viewpoint. The display medium 200 displays the second content, in which the brightness of each cell viewed from the second viewpoint in the second direction has a positive correlation with the value of R of the RGB components corresponding to each cell, in the second direction. The second content is formed by each pixel of each cell that is visible from the second viewpoint. The display medium 200 displays the third content, in which the brightness of each cell viewed from the third viewpoint in the third direction has a positive correlation with the value of G of the RGB components corresponding to each cell, in the third direction. The third content is formed by each pixel of each cell that is visible from the third viewpoint.

The display medium 200 according to the third embodiment can display the content that is space-saving and easy to see for both normal people and people with minority color vision, as in the first embodiment.

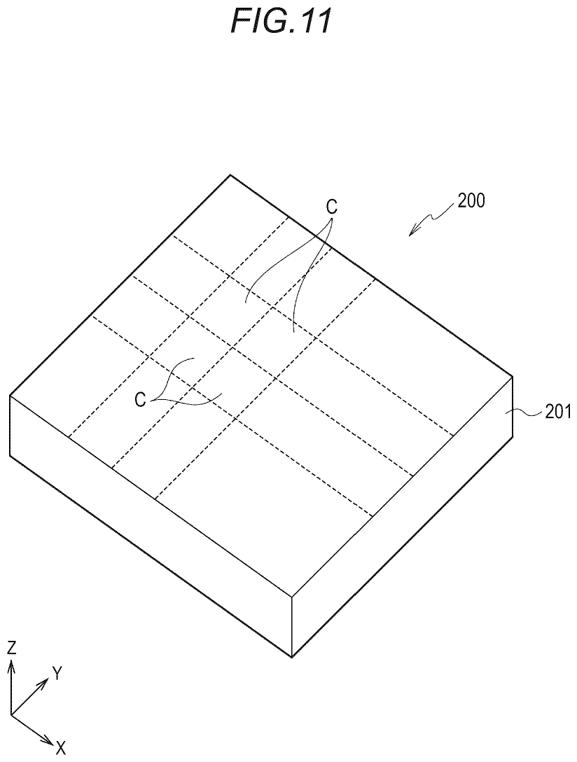

As shown in FIG. 11, the display medium 200 includes a substrate 201. The substrate 201 may have a thin sheet shape such as paper, or may have a three-dimensional shape. The upper surface of the substrate 201 may be a flat surface or may be a curved surface.

The upper surface of the substrate 101 is divided into a plurality of cells C. The plurality of cells may be provided adjacent to each other, or may be provided so as to be spaced apart from each other.

One partition P is provided in one cell C. The partition P is a surface formed on a plane crossing the substrate 201, and has a portion that is exposed when the display medium 200 is observed from each of the three directions. The partition P has a plurality of pixels on its surface.

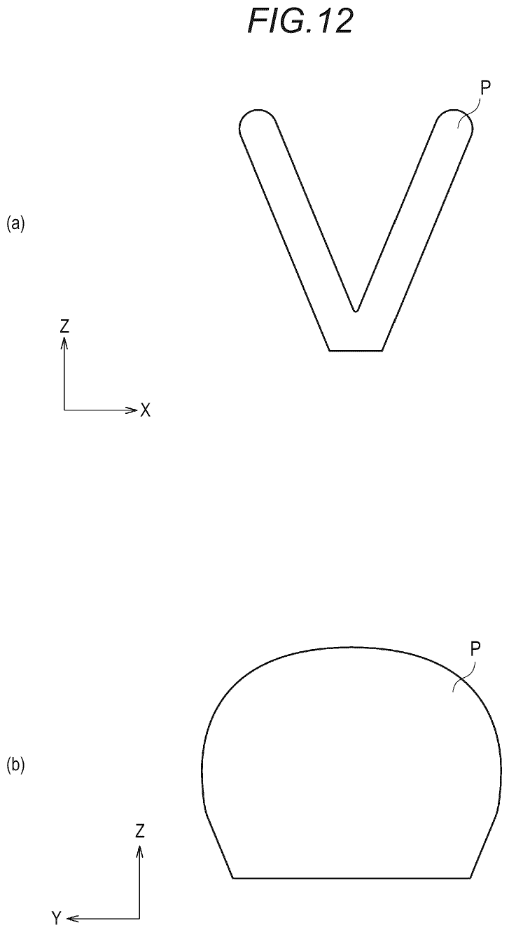

As shown in FIG. 12, the partition P is formed so as to radially divide the space on the cell C for each of the three directions from a point on the cell C. In the third embodiment, the partition P divides the first viewpoint, the second viewpoint, and the third viewpoint on the X axis above the display medium 200. The partition P may be provided so as to be in contact with the outer edge of the cell C and not to be connected to the partitions of adjacent cells. Alternatively, the partition P may be provided so as to be connected to the partition of an adjacent cell C.

The skeleton of the partition P is a part of a Voronoi plane in a Voronoi diagram having points virtually provided in each of the three directions as generating points.

The partition P has a plurality of pixels on its surface. The display medium 200 displays the first content including RGB components with pixels visible from the first viewpoint among a plurality of pixels. The display medium 200 displays the second content, in which the brightness of each cell has a positive correlation with the value of R of the RGB components corresponding to each cell, with pixels visible from the second viewpoint among the plurality of pixels. The display medium 200 displays the third content, in which the brightness of each cell has a positive correlation with the value of G of the RGB components corresponding to each cell, with pixels visible from the third viewpoint among the plurality of pixels.

In addition, the combination of a viewpoint and the content to be displayed with respect to the viewpoint is set appropriately. For example, pixels visible from the second viewpoint may display the content in which the brightness of each cell has a positive correlation with the value of G of the RGB components corresponding to each cell, and pixels visible from the third viewpoint may display the content in which the brightness of each cell has a positive correlation with the value of R of the RGB components corresponding to each cell.

People with minority color vision can visually recognize the composition of the content by repeatedly viewing the first content, the second content, and the third content while changing the viewpoint.

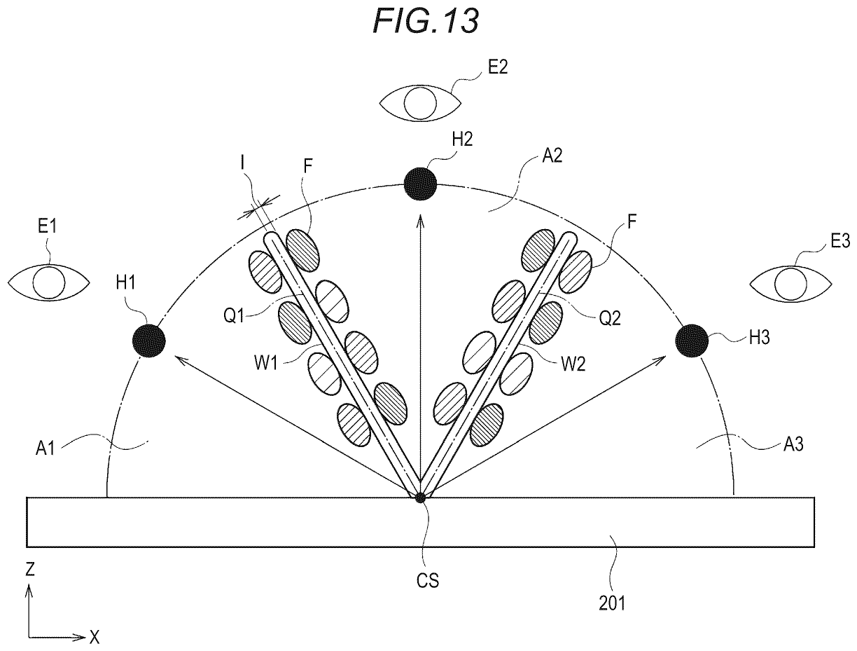

The shape of the partition P will be described with reference to FIG. 13. In the third embodiment, a Voronoi diagram is virtually formed for generating points virtually provided in a direction in which the content is displayed. The partition P includes, in its skeleton, the Voronoi plane in the Voronoi diagram. The partition P is obtained by adding flesh to the Voronoi plane, which is the skeleton. The surface of the partition P includes a plane parallel to the Voronoi plane.

In the example shown in FIG. 13, three viewpoints E1, E2, and E3 are provided. Generating points H1, H2, and H3 are provided on the line of sight when the center Cs of the cell C is viewed from each of the viewpoints E1, E2, and E3. The generating points H1, H2, and H3 are provided on a virtual sphere having a predetermined radius centered on the center Cs of the cell C.

The partition P has two shielding members W1 and W2. The shielding members W1 and W2 divide the space above the cell C where the partition P is provided into three regions.

The shielding member W1 has a Voronoi plane Q1 as its skeleton and is fleshed out to a thickness 1. The shielding member W2 has a Voronoi plane Q2 as its skeleton and is fleshed out to a thickness 1. In addition, the distal end of the shielding member W1 is formed in a circular shape having a radius 1.

The shielding member W1 divides the space above the cell C into a space A1 corresponding to the viewpoint E1 and a space A2 corresponding to the viewpoint E2. The shielding member W2 divides the space above the cell C into the space A2 corresponding to the viewpoint E2 and a space A3 corresponding to the viewpoint E2.

Of the surface of the partition P, a portion that is exposed when the display medium 200 is observed from a predetermined specified direction among three directions has a portion that is shielded when the display medium 200 is observed from a direction other than the predetermined specified direction among the three specified directions. A pixel F on the surface of the partition P may not be visible from the other specified directions even when the pixel F is exposed in one or more of the three directions. The surface of the partition P expresses the color of the content corresponding to the direction of exposure. Therefore, since the display medium 200 can express parts of different contents in a plurality of specified directions, it is possible to display a plurality of contents with a wide color gamut and high brightness.

For example, in the example shown in FIG. 13, the surface of the shielding member W1 on the side of the space Al has a portion that can be visually recognized from the viewpoint E1 but cannot be visually recognized from the viewpoint E2 or the viewpoint E3. The surface of the shielding member W1 on the side of the space A2 has a portion that can be visually recognized from the viewpoint E2 but cannot be visually recognized from the viewpoint E1 or the viewpoint E3. The surface of the shielding member W2 on the side of the space A2 has a portion that can be visually recognized from the viewpoint E2 but cannot be visually recognized from the viewpoint E1 or the viewpoint E3. The surface of the shielding member W2 on the side of the space A3 has a portion that can be visually recognized from the viewpoint E3 but cannot be visually recognized from the viewpoint E1 or the viewpoint E2.

Each surface of the partition P is formed so as to be easily visually recognized from one of the three directions and difficult to be visually recognized from the other two directions. Each surface of the partition P has both the effect of emitting a color that forms the content in one direction and the effect of blocking light from directions other than that direction. Therefore, the display medium 200 can display different contents in three directions. In addition, the display medium 200 can display the content with a wide color gamut and high brightness in three directions. Since the influence of the line of sight from directions other than the specified direction is suppressed for each surface of the partition P, it is possible to apply a suitable color to the surface observed from the specified direction.

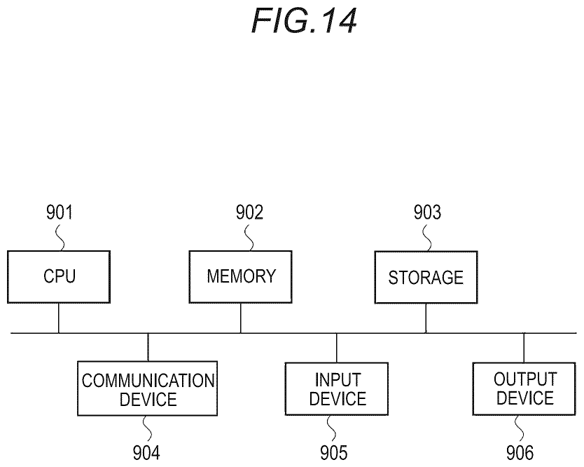

Next, a processing apparatus for assigning a color to each pixel of the display medium 200 will be described. The processing apparatus has a configuration similar to that of the processing apparatus 110 according to the second embodiment shown in FIG. 14.

The condition data 112 is data that specifies a direction in which the content is to be displayed on the display medium 200. The shape data 113 is parameters related to the partition P of the display medium 200, specifically, data such as the thickness I and the size of the virtual hemisphere when cutting the Voronoi plane.

The assignment unit 117 assigns a color to each pixel in a cell to be processed so that pixels visible from the first viewpoint in the cell to be processed display a color including RGB components, pixels visible from the second viewpoint in the cell to be processed display a color having a brightness that has a positive correlation with the value of R of the RGB components, and pixels visible from the third viewpoint in the cell to be processed display a color having a brightness that has a positive correlation with the value of G of the RGB components. The pixels to which colors are assigned herein are pixels visible from any of the viewpoints among the pixels in the cell to be processed.

The assignment unit 117 specifies, among the pixels of the partition P in the cell to be processed, a group of pixels visible from the first viewpoint, a group of pixels visible from the second viewpoint, and a group of pixels visible from the third viewpoint.

The assignment unit 117 assigns a color to each pixel in each pixel group so that RGB values to be expressed in the cell to be processed, a brightness corresponding to the value of red among RGB, and a brightness corresponding to the green value can be expressed.

The processing apparatus 110 repeats the process of assigning a color to each pixel for each cell, and outputs the correspondence between a pixel and a color in each cell to the output data 115. The output data 115 is input to a manufacturing apparatus such as a printer, and the display medium 100 in which each pixel is colored with an appropriate color is output. The printer may be a 3D printer that can also form a partition.

The display medium 200 according to the third embodiment can display the content that is space-saving and easy to see for both normal people and people with minority color vision, similarly to the display medium 1 according to the first or second embodiment.

### Technique C

A display medium for displaying three different contents in three directions, including:
a substrate having a plurality of virtual cells; and
a partition that is provided in the cell, is a surface formed on a plane crossing the substrate, and has a portion exposed when the display medium is observed from each of the three directions,
wherein the skeleton of the partition includes a part of a Voronoi plane in a Voronoi diagram having a point virtually provided in each of the plurality of directions as a generating point,
a first content including RGB components is displayed with pixels visible from a first viewpoint among a plurality of pixels provided in the partition, a second content in which the brightness of each cell has a positive correlation with a value of R of the RGB components corresponding to each cell is displayed with pixels visible from a second viewpoint among the plurality of pixels, and a third content in which the brightness of each cell has a positive correlation with a value of G of the RGB components corresponding to each cell is displayed with pixels visible from a third viewpoint among the plurality of pixels, and
people with minority color vision can visually recognize the composition of the content by repeatedly viewing the first content, the second content, and the third content while changing the viewpoint.

### Technique D

A display medium for displaying three different contents in three directions, including:
a substrate having a plurality of virtual cells; and
a partition that is provided in the cell, is a surface formed on a plane crossing the substrate, and has a portion exposed when the display medium is observed from each of the three directions,
wherein the partition is provided so as to be in contact with the outer edge of the cell, and radially divides the space above the cell for each of the three directions from the cell,
a first content including RGB components is displayed with pixels visible from a first viewpoint among a plurality of pixels provided in the partition, a second content in which the brightness of each cell has a positive correlation with a value of R of the RGB components corresponding to each cell is displayed with pixels visible from a second viewpoint among the plurality of pixels, and a third content in which the brightness of each cell has a positive correlation with a value of G of the RGB components corresponding to each cell is displayed with pixels visible from a third viewpoint among the plurality of pixels, and
people with minority color vision can visually recognize the composition of the content by repeatedly viewing the first content, the second content, and the third content while changing the viewpoint.

### Modification Example of the Third Embodiment

In the third embodiment, a case where three contents are displayed in three directions has been described. However, in a modification example, a case where two contents are displayed in two directions will be described. The display medium 200 according to the modification example of the third embodiment displays the first content including RGB components in the first direction and displays the second content having a brightness, which has a positive correlation with either the value of R or the value of G of the RGB components, in the second direction, similarly to the display medium 1 according to the modification example of the first embodiment.

When the brightness of the second content has a positive correlation with the value of R, the display medium 200 displays the first content including RGB components with pixels visible from the first viewpoint among a plurality of pixels provided in the partition P, and displays the second content, in which the brightness of each cell has a positive correlation with the value of R of the RGB components corresponding to each cell, with pixels visible from the second viewpoint among the plurality of pixels. The assignment unit 117 of the processing apparatus 110 assigns a color to each pixel in a predetermined cell so that pixels visible from the first viewpoint, among the plurality of pixels provided in the partition P, display the first content including RGB components and pixels visible from the second viewpoint among the plurality of pixels display the second content in which the brightness of each cell has a positive correlation with the value of R of the RGB components corresponding to each cell. The display medium 200 displays the content that is easy to see not only for normal people but also for people with minority color vision who have difficulty perceiving red.

When the brightness of the second content has a positive correlation with the value of G, the display medium 200 displays the first content including RGB components with pixels visible from the first viewpoint, among the plurality of pixels provided in the partition P, and displays the second content, in which the brightness of each cell has a positive correlation with the value of G of the RGB components corresponding to each cell, with pixels visible from the second viewpoint among the plurality of pixels. The assignment unit 117 of the processing apparatus 110 assigns a color to each pixel in a predetermined cell so that pixels visible from the first viewpoint, among the plurality of pixels provided in the partition P, display the first content including RGB components and pixels visible from the second viewpoint among the plurality of pixels display the second content in which the brightness of each cell has a positive correlation with the value of G of the RGB components corresponding to each cell. The display medium 200 displays the content that is easy to see not only for normal people but also for people with minority color vision who have difficulty perceiving green.

The display medium 200 according to the modification example of the third embodiment can display the content that is space-saving and easy to see for both normal people and people with minority color vision.

As the processing apparatus 10 according to the present embodiment described above, for example, a general-purpose computer system including the CPU (Central Processing Unit, processor) 901, the memory 902, the storage 903 (HDD: Hard Disk Drive, SSD: Solid State Drive), a communication device 904, an input device 905, and an output device 906 is used. In this computer system, the CPU 901 executes a program loaded onto the memory 902, thereby realizing each function of the processing apparatus 10. In addition, the general-purpose computer system is also used as the processing apparatus 110, similarly to the processing apparatus 10.

In addition, the processing apparatus 10 may be implemented by one computer, or may be implemented by a plurality of computers. In addition, the processing apparatus 10 may also be a virtual machine implemented in a computer.

The program of the processing apparatus 10 can be stored in a computer-readable recording medium such as an HDD, an SSD, a USB (Universal Serial Bus) memory, a CD (Compact Disc), or a DVD (Digital Versatile Disc), or can be distributed through a network. The computer-readable recording medium is, for example, a non-transitory recording medium.

In addition, the present disclosure is not limited to the embodiments, and various modifications can be made within the scope of the present disclosure.

Any part or all of the functional units described in the present disclosure may be realized by a program. The programs mentioned in the present disclosure may be distributed by being non-temporarily recorded on a computer-readable recording medium, or may be distributed through a communication line (including wireless communication) such as the Internet, or may be distributed in a state of being installed on any terminal.

Based on the above description, those skilled in the art may conceive additional advantages and various modifications of the present disclosure, but the aspects of the present disclosure are not limited to the individual embodiments described above. Various additions, modifications, or partial deletions are possible without departing from the conceptual idea and spirit of the present disclosure derived from the contents defined in the claims and their equivalents.

For example, what is described as a single apparatus (or member; the same hereinbelow) in the present disclosure (including what is drawn as a single apparatus in the diagrams) may be implemented by a plurality of apparatuses. Conversely, what is described as a plurality of apparatuses in the present disclosure (including what is drawn as a plurality of apparatuses in the diagrams) may be implemented by a single apparatus. Alternatively, some or all of the means or functions included in one apparatus may be included in another apparatus. In addition, a “system” may include one apparatus, or may include two or more apparatuses.

In addition, all matters described in the present disclosure are not essential requirements. In particular, any matter described in the present disclosure but not claimed may be considered optional additional matter.

In addition, it should be noted that the applicant is merely aware of the publicly known inventions described in the literatures in “Citation List” section of the present disclosure and that the present disclosure is not necessarily intended to solve the problems in the publicly known inventions described in the literatures. The problems to be solved by the present disclosure should be determined taking into account the entire present disclosure. For example, when it is described in the present disclosure that a particular configuration produces a predetermined effect, it can also be said that the configuration solves a problem that is the opposite of the predetermined effect. However, it is not intended that such a specific configuration is necessarily an essential requirement.

### REFERENCE SIGNS LIST

1, 100, 200: display medium
10, 110: processing apparatus
11, 111: input image data
12, 114: cell color data
13, 115: output data
16, 116: calculation unit
17, 117: assignment unit
112: condition data
113: shape data
901: CPU
902: memory
903: storage
904: communication device
905: input device
906: output device
A: space
C: cell
G: color region
H: generating point
K: sub-cell
L: layer
M: substrate
N: transparent layer
P: partition
T: protruding member
W: shielding member
φ: azimuth angle

1.-8. (canceled)

9. A display medium for displaying contents visually recognizable by normal people and people with minority color vision,
wherein a first content including RGB components is displayed in a first direction, and
a second content having a brightness that has a positive correlation with either a value of R or a value of G of the RGB components is displayed in a second direction.

10. The display medium according to claim 9,
wherein a ratio of the one value to a range of the one value of the RGB components of the first content corresponds to a ratio of a brightness value to a range of a brightness of the second content.

11. The display medium according to claim 9,
wherein the display medium has a plurality of cells on its surface,
the cell has a protruding member having a light blocking property and a color region on its surface, and
the cell is formed so that the color region visually recognized differs when viewed from each of a first direction and a second direction.

12. The display medium according to claim 9,
wherein the display medium has a plurality of cells on its surface,
the cell includes a partition that radially divides a space above the cell in two directions and has a color region, and
the cell is formed so that the color region visually recognized differs when viewed from each of a first direction and a second direction.

13. The display medium according to claim 9,
wherein the display medium includes:
an upper surface layer formed of a transparent member, having a plurality of upper surface cells, and having a color region in each of the plurality of upper surface cells; and
a lower surface layer formed of a transparent member, having a plurality of lower surface cells, and having a color region in each of the plurality of lower surface cells,
cells including the upper surface cells of the upper surface layer and the lower surface cells of the lower surface layer overlapping the upper surface cells are formed so that, when viewed from each of the first and second directions, portions of the color regions of the lower surface cells overlapping the color regions of the upper surface cells are different from each other,
the first content including the RGB components is displayed in the first direction with each cell viewed from a first viewpoint in the first direction, and
the second content in which a brightness of each cell viewed from a second viewpoint in the second direction has a positive correlation with the one value of the RGB components corresponding to each cell is displayed in the second direction.

14. A processing apparatus for assigning a color to a color region in a display medium including an upper surface layer formed of a transparent member, having a plurality of upper surface cells, and having a color region in each of the plurality of upper surface cells and a lower surface layer formed of a transparent member, having a plurality of lower surface cells, and having a color region in each of the plurality of lower surface cells, the processing apparatus comprising:
a calculation unit that calculates each value of RGB of a color to be displayed in each cell for a content to be displayed in a first direction; and
an assignment unit that assigns a color to each pixel of the upper surface cell and the lower surface cell so that for each cell, a color of each calculated value of RGB is displayed in the first direction and a color having a brightness that has a positive correlation with either one of an R value and a G value is displayed in a second direction,
wherein cells including the upper surface cells of the upper surface layer and the lower surface cells of the lower surface layer overlapping the upper surface cells are formed so that, when viewed from each of the first and second directions, portions of the color regions of the lower surface cells overlapping the color regions of the upper surface cells are different from each other,
each of the upper surface cells and the lower surface cells has the color region and a transparent region to which no color is given, and
the color region is provided at a position away from an end of each of the upper surface cells and the lower surface cells, and includes a plurality of pixels.

15. A processing method for assigning a color to a color region in a display medium including an upper surface layer formed of a transparent member, having a plurality of upper surface cells, and having a color region in each of the plurality of upper surface cells and a lower surface layer formed of a transparent member, having a plurality of lower surface cells, and having a color region in each of the plurality of lower surface cells, the processing method comprising:
calculating each value of RGB of a color to be displayed in each cell, for a content to be displayed in a first direction, using a computer; and
assigning a color to each pixel of the upper surface cell and the lower surface cell using the computer so that for each cell, a color of each calculated value of RGB is displayed in the first direction and a color having a brightness that has a positive correlation with either one of an R value and a G value is displayed in a second direction,
wherein cells including the upper surface cells of the upper surface layer and the lower surface cells of the lower surface layer overlapping the upper surface cells are formed so that, when viewed from each of the first and second directions, portions of the color regions of the lower surface cells overlapping the color regions of the upper surface cells are different from each other,
each of the upper surface cells and the lower surface cells has the color region and a transparent region to which no color is given, and
the color region is provided at a position away from an end of each of the upper surface cells and the lower surface cells, and includes a plurality of pixels.

16. A non-transitory computer readable medium with instructions causing a computer to function as the processing apparatus according to claim 14.
